(19) United States
(12) Patent Application Publication
(10) Pub. No.: US 2008/0109552 A1
(43) Pub. Date: May 8, 2008

(54) INTERNET APPLICATION FOR YOUNG CHILDREN

(75) Inventors: DORON TAMIR, Herzliya (IL); Einat Spector, Kfar Saba (IL); Moti Menachem, Hadera (IL); Alona Abt, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Hop Internet Ltd, Tel Aviv (IL)

(21) Appl. No.: 11/555,698

(22) Filed: Nov. 2, 2006

(51) Int. Cl. G06F 15/16

(52) U.S. Cl. 709/229

(57) ABSTRACT

A computerized method for providing a child with Internet based services. The child uses a client computer running an Internet browser which is attached to a server over the Internet. A contact list is prepared for the child by a guardian, and the contact list includes at least one contact person. A multimedia user interface is provided to the child using the Internet browser. The child accesses using the multimedia user interface at least one Internet service including (i) an Internet-page-construction application for building a personalized Internet page and storing the Internet page on the server; (ii) a client electronic mail application which transfers messages between the child and the contact person(s); and (iii) an album of content including computer files by the child and stored on the server. The Internet page and the album are accessible preferably only by the contact person(s).

### FIELD AND BACKGROUND OF THE INVENTION

The present invention relates to network communications and more particularly, to an Internet application which provides young children with supervised Internet services including electronic mail, personal Internet site construction, a personalized album and a contact list.

As children use computers, there is a need for controlling and restricting Internet access, and also for guiding and monitoring their activities. In US patent application publication 2003/0207237 a method is disclosed for guiding a young child, in a controlled virtual environment or playground. A guardian establishes parameters and the child is presented with the controlled environment which is governed, in part, by the guardian-provided parameters. Data is accumulated concerning interactions and movements of the child's selector device within the controlled environment. The child is provided with guidance on the basis of the accumulated data within the constraints of the parameters provided by the guardian. The guardian can be provided with reports concerning the accumulated data.

In US patent application publication US20050091385, method is disclosed for children to safely send and receive electronic mail. When an electronic mail message is sent to a child; a server system intercepts the electronic mail message, redirecting the electronic mail message to the account of the child's, parent. The parent reviews the electronic mail message, and based on the parent's discretion deletes or forwards the electronic mail message to the child's account. When a child sends an electronic mail message, a server system intercepts the electronic mail message, redirecting the electronic mail message to the account of the child's parent. The parent reviews the electronic mail message and based on the parent's discretion deletes or forwards the electronic mail message to the electronic mail message's addressees. The interception, temporary storage and forwarding of electronic mail messages are transparent to both the sender and receiver.

The use of World Wide Web over the Internet dominates interpersonal long distance communications and information transfer. However, use of current Internet applications, e.g. electronic mail are not available for young children because user interfaces of prior art client applications require reading comprehension and motile skills behind the ability of a typical pre schooler. As a result, if a young child wishes to send independently electronic content such as a simple text message to a friend or grandparent, or photograph, or build and maintain a personal Internet site, intervention of an older person is required to write and deliver the message using a prior art application, e.g. electronic mail client application.

There is thus a need for, and it would be highly advantageous to have a client application with a multimedia interface appropriate for a child for communicating over the Internet and specifically an interface which the child uses for receiving and sending electronic mail messages, building a personal Internet site, storage of albums and maintaining a list of contact persons.

The Internet, is the worldwide, publicly accessible system of interconnected computer networks that transmit data by packet switching using the standard Internet Protocol (IP). The World Wide Web is a collection of interconnected documents, linked by hyper links and URLs, and is accessible using the Internet.

Macromedia Flash, or simply Flash, refers to both the Macromedia Flash Player and to a multimedia authoring program used to create content for it as well as games or movies created using the program. The Flash Player, developed and distributed by Adobe Systems (who bought Macromedia), is a client application available in most dominant web browsers Flash features support for vector and raster graphics, a scripting language called ActionScript and bidirectional streaming of audio and video. Strictly, Macromedia Flash is the integrated development environment (IDE) and Flash Player is the virtual machine used to run the Flash files, but in colloquial language these have become mixed: “Flash” can mean either the authoring environment, the player, or the application files. Since its introduction in 1996, Flash technology is useful for adding animation and interactivity to Web pages and available in many software development producers. Flash is commonly used to create animations and advertisements; to design web-page elements; to add video to web sites; and, develop Rich Internet Applications. The Flash files, traditionally called “flash movies”, usually have a .swf file extension and may appear as an element of a web page or to be “played” in the standalone Flash Player.

FIG. 1 illustrates a client-server network including client 101C transferring data with server 101S over a wide area network 111. FIG. 2 illustrates a computer, for instance client 101C and server 101S, which includes a processor 201, a storage mechanism including a memory bus 207 to store information in memory 209 and a network interface 204, and a display interface 206 each operatively connected to processor 201 with a peripheral bus 203. Computer 101 further includes a data input mechanism 211, e.g. disk drive from a program storage device 213, e.g. optical disk. Data input mechanism 211 is operatively connected to processor 201 with peripheral bus 203.

The term “multimedia” user interface is a graphic user interface using graphical images or icons with the optional addition of sound, typically a voice, which is prompted when an icon is selected.

The term “child” as used herein includes a young child aged typically three to eight years but under some circumstances such as a person with learning disabilities may include an person older than eight years.

The term “guardian” as used herein includes one or more parents or otherwise guardians of a child including older siblings, relatives, baby-sitters or any other older persons.

Reference: http://en.wikipedia.org/wiki/Macromedia_Flash

### SUMMARY OF THE INVENTION

According to the present invention there is provided a computerized method for providing a child with Internet based services. The child uses a client computer running an Internet browser which is attached to a server over the Internet. A contact list is prepared for the child by a guardian, and the contact list includes at least one contact person. A multimedia user interface is provided to the child using the Internet browser. The child accesses using the multimedia user interface at least one Internet service including (i) an Internet-page-construction application for building a personalized Internet page and storing the Internet page on the server; (ii) a client electronic mail application which transfers messages between the child and the contact person(s); and (iii) an album of content including computer files by the child and stored on the server. The Internet page and the album are accessible preferably only by the contact person(s). The multimedia user interface preferably includes a virtual bedroom of the child. The Internet-page-construction application is accessed when the child selects a virtual computer display; the client electronic mail application is accessed when the child selects a virtual mail board, the album is accessed when the child selects a virtual album.

According to the present invention there is provided a server application for providing a child with Internet based services. The child uses a client computer ruining an Internet browser attached to the server over the Internet. The server application includes (a) a contact-list-preparation module used by a guardian for preparing for the child a contact list including contact person(s), a multimedia user interface used by the child, for accessing an Internet based service including:
(i) an Internet-page-construction application for building a personalized Internet page and storing the Internet page on the server; (ii) a client electronic mail application which transfers messages between the child and the contact person(s); and (iii) an album of content including computer files by the child and stored on the server. The Internet page and the album are accessible preferably only by the contact person(s). The multimedia user interface for the client electronic mail application preferably includes a virtual mail board. Unread message icons appear as unopened envelopes on the virtual mail board A read message icon appears as a mailbox attached to the virtual mail board and a new message icon appears as a writing instrument and paper on the virtual mail board

According to the present invention there is provided a program storage device readable by a machine, tangibly embodying a program of instructions executable by the machine to perform a method for providing a child with Internet based services, the child using a client computer running an Internet browser operatively attached to a server over the Internet, the method as disclosed herein.

According to the present invention there is provided a data stream for providing a child with Internet based services, the child using a client computer running an Internet browser operatively attached to a server over the Internet, using a method as disclosed herein.

According to the present invention there is provided the Internet service, provided to a child, the child using a client computer ruining an Internet browser operatively attached to a server over the Internet, using a method as disclosed herein.

### BRIEF DESCRIPTION OF THE DRAWINGS

The invention is herein described, by way of example only, with reference to the accompanying drawings, wherein:

FIG. 1 is a prior art drawing of a conventional client server network used to practice embodiments of the present invention;

FIG. 2 is a simplified prior art drawing of a client and/or server computer used to practice embodiments of the present invention;

FIG. 3 is a simplified software module structure of a portion of an Internet application for young children, according to an embodiment of the present invention;

FIG. 4 is a sample screen layout “MY ROOM” of a computer display while operating an Internet application, according to an embodiment of the present invention;

FIG. 5 is a virtual message board, according to an embodiment of the present invention;

FIG. 6 illustrates a page of a virtual album, according to an embodiment of the present invention;

FIG. 7 illustrates a screen layout of a single Internet page while being constructed by a child, according to an embodiment of the present invention; and

FIG. 8 is a simplified flow diagram of a process for building a contact list for the child.

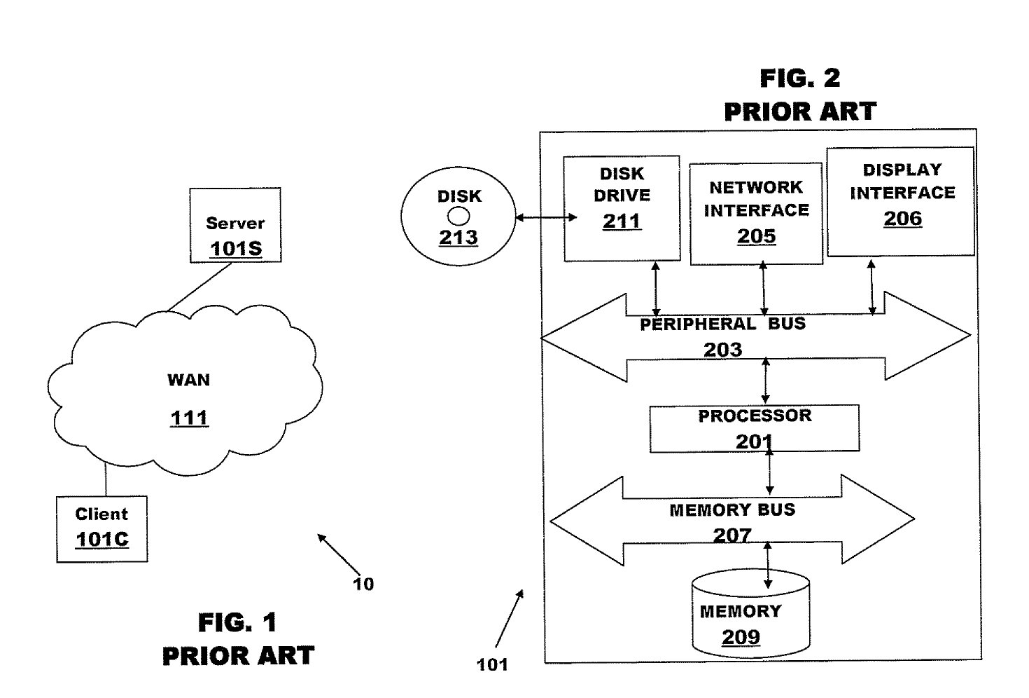

### DESCRIPTION OF THE PREFERRED EMBODIMENTS

The present invention is of a system and method which provides young children with supervised Internet services including electronic mail, personal Internet site construction, a personalized album and a contact list.

The principles and operation of a system and method of providing Internet services to children, according to the present invention, may be better understood with reference to the drawings and the accompanying description.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, principal intentions of the present invention are to: (1) provide a multimedia user interface for children to enable them to communicate using electronic mail, build a personalized Internet site and maintain albums of personal content on the Internet; and (2) provide a supervised environment wherein electronic mail messages are sent solely to contact persons previously selected by a guardian and access to the child's Internet site is limited to the contact persons.

The multimedia user interface typically uses a simultaneous combination of graphic images, and/or sound and/or text preferably in large easy-to read fonts. The cursor is moved across the computer display by the child with a mouse or other input device and when an icon is optional selection is reached by the cursor, the application uses the speaker output of computer 101 to explain to the child the purpose of the icon.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

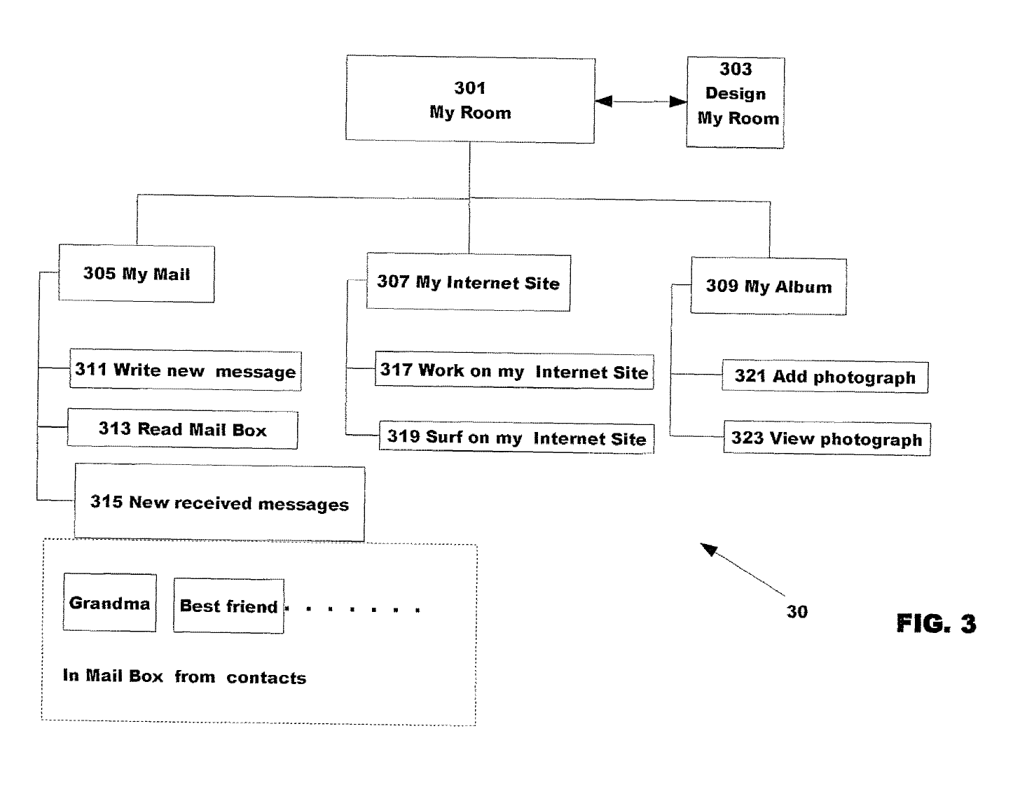

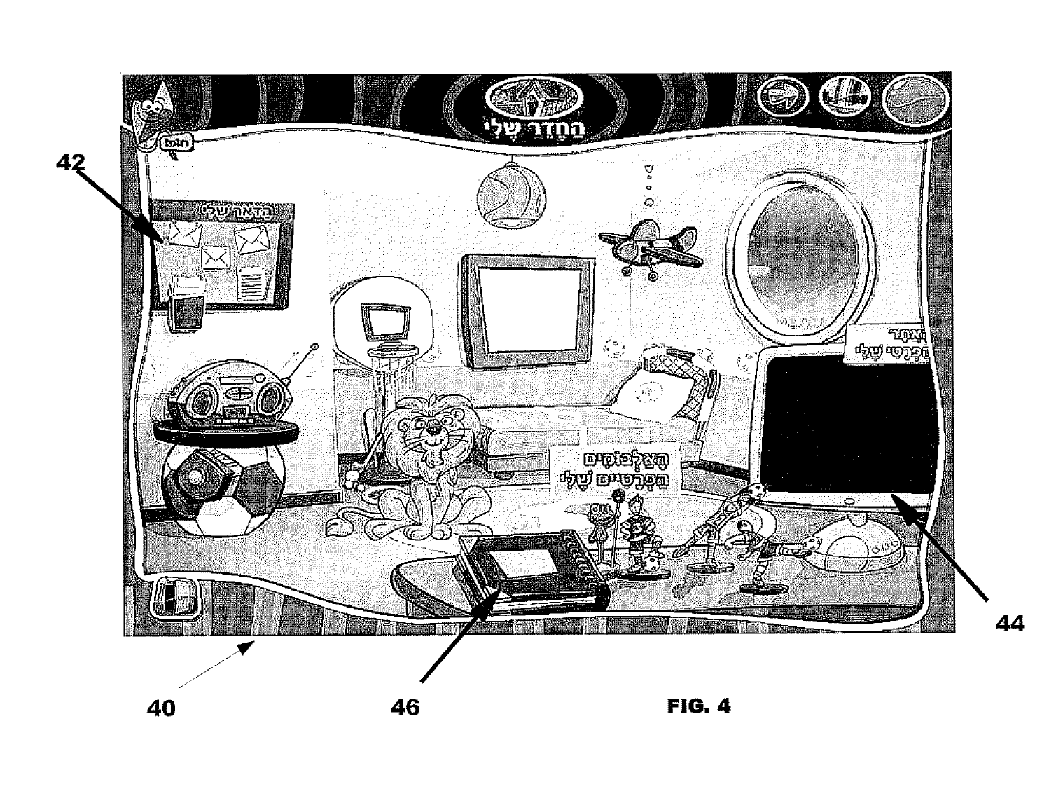

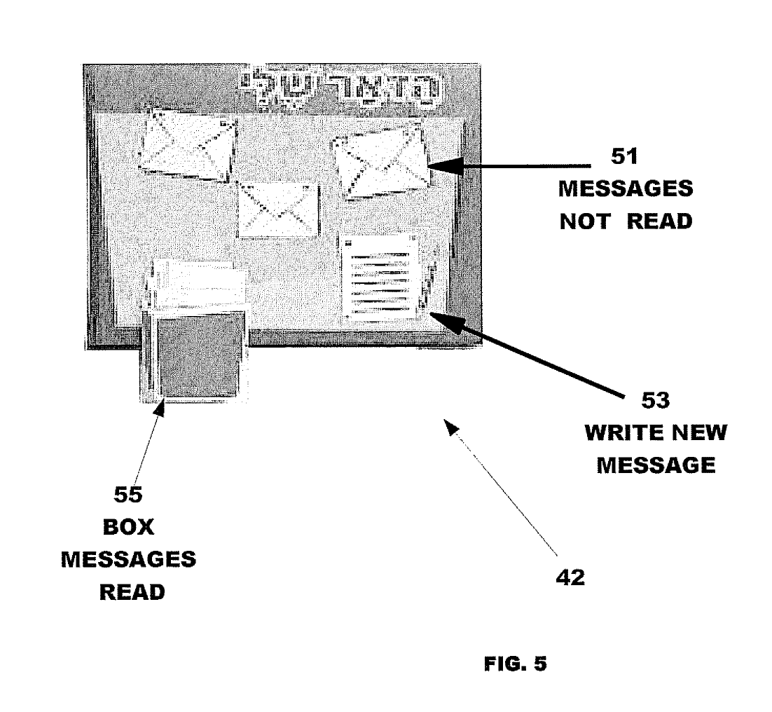

Referring now to the drawings, FIG. 3 illustrates a simplified software module structure of application 30 of a portion of all Internet application for young children, according to an embodiment of the present invention. Reference is also made to FIG. 4 a sample screen layout “My Room” 40 of a computer display while operating Internet application 30. A room design 40 is typically designed in module 303 in application 30 by the child, by selecting objects, e.g. airplane toy, ball, doll within MY ROOM 40. Upon selection, a pictorial choice of objects appears either serially or in parallel. By selecting the different objects in “My Room” 40, the child redesigns (block 303) “My Room” 40 according to personal taste. Preferably, within “My Room” module 301 different icons, when selected by the child, launch different portions of application 30. Specifically, selection of message board 42 launches an electronic message module 305; selection of computer screen 44 launches a personal Internet site module 307 and selection of a photograph album 46 launches a virtual album module 309.

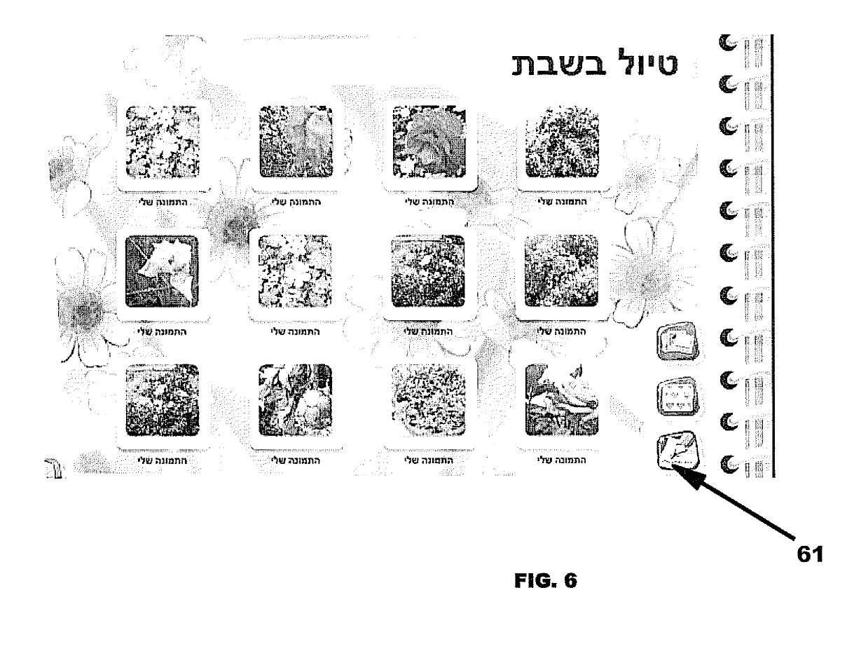

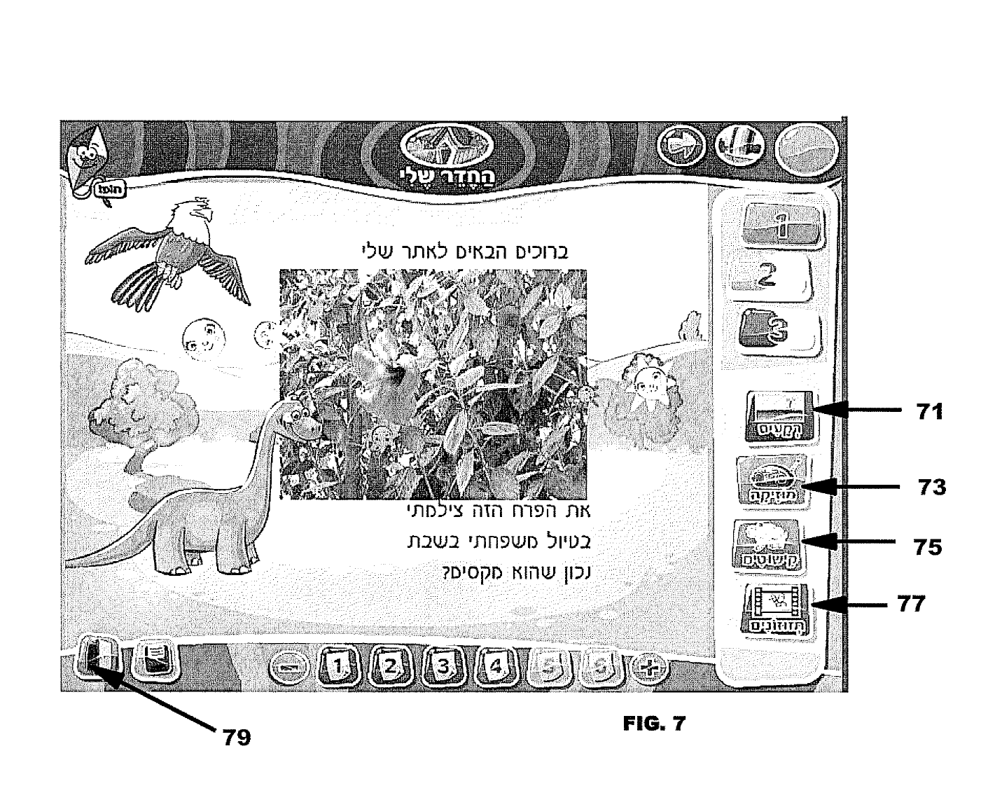

Reference is now made to FIG. 5 which illustrates a virtual message board 42 according to an embodiment of the present invention. Icons for unread messages appear as unopened envelopes 51 pinned to message board 42. An icon 53 for drafting a new message appears as a pencil and paper pinned on message board 42. An icon 55 for messages already read appears as a box 55 attached to message board 42. According to a preferred embodiment of the present invention, messages are received (module 315) only contacts (e.g. best friend, Grandma) in a contact list as previously defined by a guardian.

Referring again to application 30 (FIG. 3) and My Room 40 (FIG. 4) when album 46 is selected, a personal collection or album appears. Reference is now made to FIG. 6 which shows a layout of a page of photograph album 46 after selection. The child who owns the album may select a photograph and send the photograph by selecting icon 61. According to a preferred embodiment of the present invention, the child may only share content with one of his/her contacts in a contact list previously prepared by a guardian.

Referring again to “My Room” 40 of FIG. 4, when computer screen 44 is selected, personal Internet site module 307 is launched. The child may select working (module 317) on the his/her personal Internet site or browse (block 319) within the site. The site is built using a selection of icons which add for instance backgrounds 71, music 73, decorations 75 and animations 77. Each action of the child is numbered and recorded and may be re-edited in the future. An icon 79 of a door is used to save the work and exit from Internet building module 317. According to a preferred embodiment of the present invention, only members of a contact list prepared by a guardian is allowed access to the child's personal Internet site.

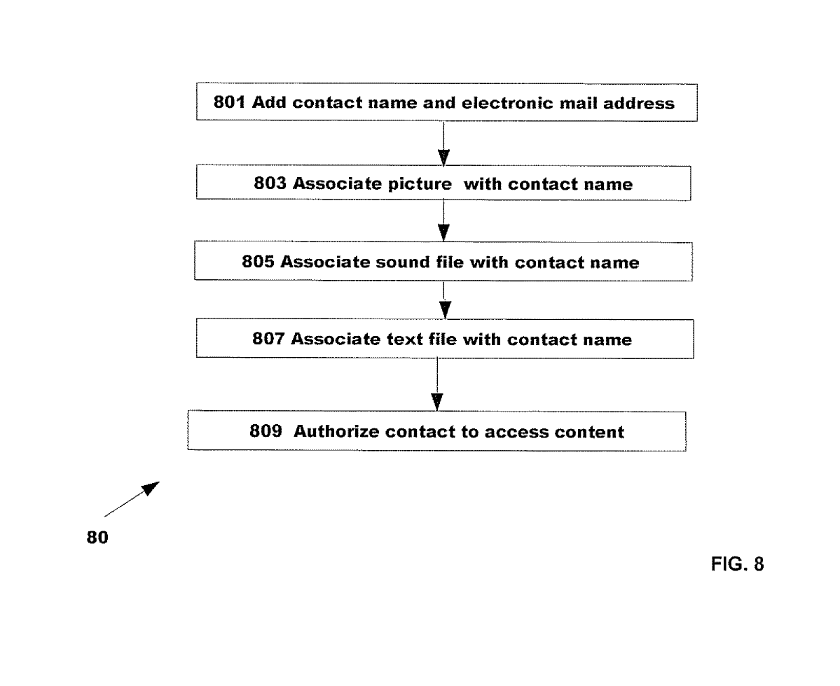

Reference is now made to FIG. 8, a simplified block diagram of method 80 for preparing a contact list in application 30, according to the present invention. A guardian of the child, adds (step 801) a contact name and electronic mail address in an appropriate list or menu. The guardian attaches (step 803) or associates an image, e.g. photograph, or caricature with contact name and address. Optionally the guardian further attaches or associates (step 805) a text to be presented to the child when the contact is selected or a sound file associated (step 807) with the contact. The contact is preferably sent an electronic mail message with a key or special link authorizing the contact to browse at the personal Internet site of the child send and an address to send electronic mail messages to the child. Preferably, electronic mail messages from only members of the contact list are presented to the child by electronic mail application 305.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

While the invention has been described with respect to a limited number of embodiments, it will be appreciated that many variations, modifications and other applications of the invention may be made.

What is claimed is:

1. A computerized method for providing a child with Internet based services, the child using a client computer running an Internet browser operatively attached to a server over the Internet, the method comprising the steps of:
(a) preparing a contact list by a guardian for the child, wherein said contact list includes at least one contact person;
(b) providing a multimedia user interface to the child using said Internet browser;
(c) accessing by the child using said multimedia user interface at least one Internet service selected from the group of the Internet based services consisting of:
(i) an Internet-page-construction application for building a personalized Internet page and stores said Internet page on the server;
(ii) a client electronic mail application which transfers messages between the child and said at least one contact person; and
(iii) an album of content including computer files by the child and stored on the server.

2. The computerized method, according to claim 1, wherein said Internet page is accessible solely by said at least one contact person.

3. The computerized method, according to claim 1, wherein said album is accessible solely by said at least one contact person.

4. The computerized method, according to claim 5, wherein said multimedia user interface includes a virtual bedroom of the child, wherein said accessing said Internet-page-construction application is performed when the child selects a virtual computer display; wherein said accessing said client electronic mail application is performed when the child selects a virtual mail board, and said accessing said album is performed when the child selects a virtual album.

5. A server application for providing a child with Internet based services, wherein the child uses a client computer running an Internet browser operatively attached to the server over the Internet, the server application comprises:
(a) a contact-list-preparation module used by a guardian for preparing for the child a contact list including at least one contact person;
(b) a multimedia user interface used by the child
wherein the child uses said multimedia user interface for accessing at least one service selected from the group of the Internet based services consisting of:
(i) an Internet page construction application for building a personalized Internet page and stores said Internet page on the server;
(ii) a client electronic mail application which transfers messages between the child and said at least one contact person; and
(iii) an album of content including computer files by the child and stored on the server.

6. The server application, according to claim 5, wherein said Internet page is accessible solely by said at least one contact person.

7. The server application, according to claim 5, wherein said album is accessible solely by said at least one contact person.

8. The server application, according to claim 5, wherein said multimedia user interface for said client electronic mail application includes a virtual mail board wherein unread message icons appear as unopened envelopes on said virtual mail board, wherein a read message icon appears as a mailbox attached to the virtual mail board and wherein a new message icon appears as a writing instrument and paper oil said virtual mail board

9. A program storage device readable by a machine, tangibly embodying a program of instructions executable by the machine to perform a method for providing a child with Internet based services, the child using a client computer running an Internet browser operatively attached to a server over the Internet, the method comprising the steps of:
(a) preparing a contact list by a guardian for the child, wherein said contact list includes at least one contact person;
(b) providing a multimedia user interface to the child using said Internet browser;
(c) accessing by the child using said multimedia user interface at least one service selected from the group of the Internet based services consisting of:
(i) an Internet page construction application for building a personalized Internet page and stores said Internet page on the server;
(ii) a client electronic mail application which transfers messages between the child and at least one contact person; and
(iii) an album of content including computer flies by the child and stored on the server.

10. A data stream for providing a child with Internet based services, the child using a client computer running an Internet browser operatively attached to a server over the Internet, using the method comprising the steps of claim 1.

11. The at least one Internet service of claim 1, provided to a child, the child using a client computer ruining an Internet browser operatively attached to a server over the Internet, using the method comprising the steps of claim 1.
